(19) United States
(12) Patent Application Publication
(10) Pub. No.: US 2025/0125631 A1
(43) Pub. Date: Apr. 17, 2025

(54) CIRCUIT ARRANGEMENT AND METHOD FOR DISCHARGING A BIAS TEE CAPACITOR AND QUANTUM SIGNAL GENERATOR WITH SAID CIRCUIT ARRANGEMENT

(71) Applicant: Rohde & Schwarz GmbH & Co. KG, München (DE)

(72) Inventors: Arsenii Krasnov, Effretikon (CH); Flavio Heer, Lufingen (CH)

(21) Appl. No.: 18/484,503

(22) Filed: Oct. 11, 2023

(51) Int. Cl. H03K 3/57; G06N 10/40; H03K 3/0231; H03K 3/64

(52) U.S. Cl. CPC H02J 7/00; G06N 10/40

(57) ABSTRACT

The present invention relates to a circuit arrangement comprising: a bias tee having an input AC terminal comprising a bias tee capacitor, wherein the input AC terminal is adapted to receive at least one AC signal, wherein the AC signal comprises at least one of a positive pulse train signal and a negative discharge pulse signal; an input DC terminal, adapted to receive at least one bias DC signal; and an output interface, adapted to output a signal based on the received AC signal and the received bias DC signal, and a discharge circuit, adapted to discharge the bias tee capacitor.

### TECHNICAL FIELD

The present invention relates to a circuit arrangement, a method and a quantum signal generator with said circuit arrangement.

### BACKGROUND OF THE INVENTION

The invention is mostly described with respect to a bias tee used for the bias and control of a qubit, but the principles of the present invention have a broader scope and apply equally well to other applications of a bias tee.

A bias tee is an electrical device with three parts or terminals used to set the DC bias of a device under test (DUT). The bias tee receives a low-frequency or DC signal from a bias generator and a high-frequency (a so-called radiofrequency) or AC signal from, e.g., an arbitrary waveform generator (AWG), and outputs both signals to a connected DUT. A low-frequency port is used to set the bias, while a high-frequency port transmits the AC signal. The low-frequency port is adapted to allow the transmission of DC signals and block AC signals, whereas the high-frequency port is adapted to allow the transmission of AC signals and block DC signals.

Bias tees are therefore designed to bias a DUT while a radio-frequency signal is applied to it. Typical applications of bias tees are to perform measurements related to a DUT and/or to control the DUT.

A particular setting for the use of a bias tee is the generation of radiofrequency pulses with adjustable, stable and low noise DC bias. Such pulse signals are used to control qubits in quantum information and are often referred to as flux signals. The main requirements of those signals to provide an effective control of the qubit are a low noise (e.g., a high signal to noise ratio), low 1/f noise, a high bandwidth and a stable DC bias level.

Compared to alternative control systems, such as the combination of a digital to analog converter and a high bandwidth DC coupled amplifier, bias tees are particularly advantageous in that they provide a low 1/f noise and a good signal to noise ratio.

However, the deployment of a bias tee also generates same challenges: The radiofrequency (RF) port of the bias tee comprises a capacitor, which is used to block a possible DC component through the input AC terminal. When a DC component is present—which is the case when the RF pulse signals are unipolar—the bias tee capacitor in the radiofrequency port gets charged. As a result, the output signal gets distorted and the generation of a stable DC bias level is compromised.

A commonly used technique to increase the stability of the DC bias is to apply a compensation or pre-compensation for the duration of the pulse signal. This compensation requires an increase of the voltage of the pulse signal, which in turn leads to the bias tee capacitor getting charged quicker. This poses a twofold problem: Firstly, more power is needed to generate the pulse signal, which also implies that the width of the pulse signal is limited by the available voltage range of the RF generator. Secondly, when the pulse signal is over, the bias tee capacitor gets naturally discharged through the passive components of the bias tee in the different three ports. The discharge time is proportional to the total impedance and the capacitance. For existing bias tees, in order to achieve a 90% discharge of the bias tee capacitor more than 200 ns might be required.

According to the commonly known solutions, the bias tee capacitor can be faster discharged (typically twice as fast) if a negative pulse is applied on the radio-frequency port right after the pulse signal was applied. This, however, leads to a corresponding negative pulse on the output signal, which in some applications can be problematic. Additionally, in order to discharge the bias tee capacitor, the width of the negative pulse should roughly correspond to the sum of the pulse widths comprised in the pulse signal. This limits the repetition rate of pulse signals, since a pulse signal can only start when a negative pulse has been completed.

### SUMMARY OF THE INVENTION

Against this background, there is the need to provide a mechanism for an efficient and quick discharge of a bias tee capacitor.

Accordingly, the present invention provides a circuit arrangement, a method and a quantum signal generator having the features of the independent claims.

A first aspect of the invention provides a circuit arrangement comprising: a bias tee having an input AC terminal comprising a bias tee capacitor, wherein the input AC terminal is adapted to receive at least one AC signal, wherein the AC signal comprises at least one of a positive pulse train signal and a negative discharge pulse signal; an input DC terminal, adapted to receive at least one bias DC signal; and an output interface, adapted to output a signal based on the received AC signal and the received bias DC signal, and a discharge circuit, adapted to discharge the bias tee capacitor.

In the present invention, the discharge time of a bias tee capacitor is lower than 40 ns, preferably between 20 ns and 30 ns. The discharge time using the circuit arrangement according to the first aspect of the invention provides is a factor 2 shorter compared to using a bias tee with the same configuration but without the discharge circuit of the invention.

The input AC terminal of the bias tee is also referred to in the literature as the pulse line (or pulse port), the radiofrequency line (or RF port) or the high-frequency line (or HF port) of the bias tee. The input AC terminal is typically adapted to be connected to an AC signal generator (or radiofrequency generator), such as an arbitrary waveform generator (AWG). The input DC terminal of the bias tee is, in turn, also referred to as the bias line (or bias port) or the low-frequency line (or LF port) of the bias tee. The input DC terminal is typically adapted to be connected to a DC generator or a bias generator.

The output interface of the bias tee is typically adapted to be connected to a suitable device under test (DUT) for its control or for performing measurements in relation to it.

A positive pulse train signal refers to a unipolar signal, based on the repetition pattern of pulses that last a certain amount of time, typically of the order of 50 ns to 100 ns. A positive pulse train signal can be a pulse of square waves. Based on an offset voltage value, a positive pulse train signal corresponds to a signal that does not acquire negative voltage values.

A negative discharge pulse signal refers to a unipolar signal, based mostly on a single pulse that lasts typically of the order of 50 ns to 100 ns. The negative discharge pulse signal can be, e.g., a triangular wave or a square wave.

A discharge circuit refers to an electrical circuit with electrical elements including passive components, designed to provide a voltage discharge path for the discharge of the bias tee capacitor.

A second aspect of the present invention provides a method for discharging a bias tee capacitor, the method comprising: providing a circuit arrangement with a bias tee and a discharge circuit, the bias tee having an input DC terminal, an output interface and an input AC terminal comprising a bias tee capacitor; receiving at least one AC signal comprising a positive pulse train signal at the input AC terminal and at least a bias DC signal at the input DC terminal; and discharging the bias tee capacitor by employing the discharge circuit.

In particular, the method according to the second aspect of the invention may be carried out by the circuit arrangement according to the first aspect of the invention. The features and advantages disclosed herein in connection with the circuit arrangement of the invention are therefore also disclosed for the method, and vice versa.

According to a third aspect, the invention provides a quantum signal generator with a radiofrequency generator, adapted to generate a radiofrequency signal, and with a circuit arrangement. The circuit arrangement has a bias tee with an input AC terminal comprising a bias tee capacitor, wherein the input AC terminal is adapted to receive at least one AC signal, wherein the AC signal comprises at least one of a positive pulse train signal and a negative discharge pulse signal; an input DC terminal, adapted to receive at least one bias DC signal; and an output interface, adapted to output a signal based on the received AC signal and the received bias DC signal, and a discharge circuit, adapted to discharge the bias tee capacitor, wherein the circuit arrangement is configured to receive the radiofrequency signal generated by the radiofrequency generator through the input AC terminal.

The radiofrequency generator of the quantum signal generator can be any signal generator apparatus or device that can be programmed to generate pulse sequences designed for dealing with quantum computing applications, in particular with spin and/or superconducting qubits. The radiofrequency generator can be an arbitrary waveform generator (AWG), preferably a quantum AWG (Q-AWG) generating RF signals with microwave frequencies.

One of the main ideas underlying the present invention is to provide a circuit arrangement comprising a discharge circuit for an efficient discharge of the bias tee capacitor. The bias tee capacitor blocks the DC component of incoming AC signals and thereby gets charged. The discharge circuit provides a quick and efficient way of discharging the bias tee capacitor by providing a high current discharge path. This ensures that the discharge is fast and the output signal has a stable DC bias level.

The circuit arrangement as described above allows for a simple implementation of a method, comprising a number of steps. Initially, a circuit arrangement with a bias tee and a discharge circuit is provided, the bias tee having an input AC terminal with a bias tee capacitor, an input DC terminal and an output interface. A positive pulse train signal is input to the bias tee through its input AC terminal. For the duration of the positive pulse, a bias tee capacitor comprised in the input AC terminal blocks the DC component and gets charged. When the pulse train signal is completed, a discharge circuit becomes operational and provides a path for discharging the bias tee capacitor.

One possible advantage of the present invention is that the discharge speed of the bias tee capacitor reduces substantially the distortions of the output signal, especially when negative discharge pulse signals are employed when discharging the bias tee capacitor. The impact on the output signal is attenuated and a stable DC bias level can be provided.

Another possible advantage of the present invention is that the fast discharge of the bias tee capacitor enables a fast repetition rate of positive pulse signals, which means that the DUT, typically a qubit, can be controlled in a more efficient way.

Advantageous embodiments and further developments follow from the dependent claims as well as from the description of the different preferred embodiments illustrated in the accompanying figures.

According to some embodiments, refinements, or variants of embodiments, the input DC terminal comprises a passive component, wherein the passive component is one of a resistor, an inductance, a capacitor or any combination thereof. The passive component can be thus understood as a combination of passive elements, which can be connected in series and/or in parallel.

According to some embodiments, refinements, or variants of embodiments, the input AC terminal is adapted to receive a radiofrequency signal, preferably a microwave signal. The radiofrequency signal is typically generated at frequencies between 1 GHz and 10 GHz, i.e., at ultra high frequencies (UHF) or super high frequencies (SHF), which fall into the range of microwaves. These frequency ranges are the ones needed in quantum computing applications, e.g., to excite and control qubits.

According to some embodiments, refinements, or variants of embodiments, the discharge circuit is connected between the input DC terminal and the output interface. The discharge circuit is preferably not connected to the input AC terminal. With this configuration, the 1/f noise associated with high speed digital to analog converters used in the input AC terminal can be efficiently filtered by the bias tee.

According to some embodiments, refinements, or variants of embodiments, the discharge circuit comprises a discharge switch connected to the output interface, which is adapted to switch on and/or switch off the discharge circuit based on the AC signal.

According to some embodiments, refinements, or variants of embodiments, the discharge switch is adapted to switch on the discharge circuit when the AC signal is a positive pulse train signal and/or to switch off the discharge circuit when the AC signal is a negative discharge pulse signal.

During the duration of a positive pulse train signal, the discharge circuit can be thus idle (the discharge circuit is switched off). The fast discharge takes place from the moment when the positive pulse train signal has been fully sent. The discharge circuit can be switched off and provides a fast discharge path to the bias tee capacitor.

According to some embodiments, refinements, or variants of embodiments, the discharge switch of the discharge circuit is adapted to switch the discharge circuit when the bias tee capacitor has been fully or at least partially discharged (i.e., it has been discharged to a certain level) or when a positive pulse train signal is applied to the input AC terminal.

The discharge circuit can be switched off either when there is no more charge in the bias tee capacitor, i.e., the bias tee capacitor has been fully discharged, or when a new pulse train signal is received by the input AC terminal. In some applications, it might be advantageous to discharge the bias tee capacitor only to a certain level (e.g., to a 10%), in order to be able to bring a new radiofrequency signal into the bias tee sooner. The discharge level of the bias tee capacitor can be predetermined in order to find an optimal waiting time between two positive pulse train signals.

According to some embodiments, refinements, or variants of embodiments, the discharge circuit further comprises a voltage divider and/or an amplifier. In some further embodiments, the voltage divider can be connected to the input DC terminal of the bias tee. The amplifier can be connected in series with the voltage divider and with the discharge switch. In some preferred embodiments of the invention, the discharge circuit further comprises a capacitor connected to ground, which is further connected to the amplifier and the discharge switch.

According to some embodiments, refinements, or variants of embodiments, the discharge circuit comprises a control terminal for receiving a control signal and the circuit arrangement further comprises a discharge control unit, which is connected to the control terminal and which is configured to provide a control signal to the control terminal to control the discharge of the bias tee capacitor. The discharge control unit is to be broadly understood as any device that is capable of acquiring, obtaining, receiving or retrieving generic data from voltages and/or currents at the different points of the circuit arrangement of the invention. It can contain an algorithm based on programming code and/or executable programs or any combination thereof for processing data from voltages and/or currents. It may therefore contain, at least, a central processing unit, CPU, and/or at least one field-programmable gate array, FPGA, and/or at least one application-specific integrated circuit, ASIC and/or any combination of the foregoing. It may further comprise a working memory operatively connected to the at least one CPU and/or a non-transitory memory operatively connected to the at least one CPU and/or the working memory. It may further comprise or consist of an application program application (API).

The discharge control unit can be adapted to control the operation of the discharge switch of the discharge circuit based on at least one of the following: the duration of the pulse train signals, the discharge level of the bias tee capacitor and the presence of an incoming pulse train signal at the input AC terminal. The control signal can thus consist of an instruction to switch off or switch on the discharge circuit based on these different criteria.

The discharge control unit can be part of an arbitrary waveform generator (AWG), in particular of a quantum arbitrary waveform generator (Q-AWG).

According to some embodiments, refinements, or variants of embodiments, the discharge control unit is further configured to generate a negative discharge pulse signal. In order to ease the discharge of the bias tee capacitor, negative discharge pulse signals can be applied through the input AC terminal of the bias tee. These negative pulse signals can be generated by an AWG. The invention also foresees that, regardless of whether the discharge control unit is part of an AWG or not, the discharge control unit can generate the negative pulse signal, e.g., after a positive pulse train signal has been received by the bias tee. In some embodiments of the invention, the negative discharge pulse signal can be generated by an AWG upon request of the discharge control unit.

According to some embodiments, refinements, or variants of embodiments, the discharge control unit is further configured to switch on the discharge circuit when a negative discharge pulse signal is received at the input AC terminal.

According to some embodiments, refinements, or variants of embodiments, the output interface comprises a DUT connection terminal, which is configured to be coupled to a qubit. The invention can be preferably deployed for quantum computing applications, in particular, for the bias and control of one or more spin or superconducting qubits.

According to some embodiments, refinements, or variants of embodiments, the circuit arrangement of the invention further comprises a pre-compensation circuit, configured to modify a positive train pulse signal based on the charging level of the bias tee capacitor.

Pre-compensation is a technique used to correct for the progressive charging of the bias tee capacitor when a positive pulse train signal comprising a DC component is provided to the bias tee. Pre-compensation consists in increasing the voltage of a positive pulse train signal in a way that the output signal maintains a stable DC bias level.

In some embodiments of the invention, the pre-compensation circuit of the circuit arrangement of the invention can be controlled by the discharge control unit.

According to some embodiments, refinements, or variants of embodiments, at least one of the pulse train signal and the discharging pulse signal received by the input AC terminal are digital signals.

According to some embodiments, refinements, or variants of embodiments, the circuit arrangement of the invention further comprises at least one digital to analog converter, arranged at the input AC terminal in order to receive at least one of a digital positive pulse train signal and a digital negative discharge pulse signal and configured to convert the at least one of the digital positive pulse train signal and the digital negative discharge pulse signal into an analog positive pulse train signal and an analog negative discharge pulse signal, respectively.

According to some embodiments, refinements, or variants of embodiments, the circuit arrangement further comprises a second discharge switch arranged at the input AC terminal and adapted to be switched off after a positive pulse train signal has been received. In these embodiments, the bias tee capacitor is further discharged by connecting the input AC terminal side of the bias tee capacitor to ground. In some embodiments of the invention, the discharge control unit can be further configured to switch on the discharge circuit and the second discharge switch when a positive pulse train signal has been completely received. In some further embodiments, the discharge with a second discharge switch can be effected in combination with the generation of a negative discharge pulse signal.

According to some embodiments, refinements, or variants of embodiments, the circuit arrangement is configured to receive a positive pulse train signal at least every 30 ns. The fast discharge of the bias tee capacitor provided by the invention enables a high repetition rate for the positive pulse train signals, which is typically a factor two quicker than with conventional discharge techniques.

Where appropriate, the above-mentioned configurations and implementations can be combined with each other as desired, as far as this is reasonable.

Further possible configurations, developments and implementations of the invention also include combinations, which are not explicitly mentioned, of features of the invention which have been described previously or are described in the following with reference to the embodiments. In particular, in this case, a person skilled in the art will also add individual aspects as improvements or supplements to the basic form of the present invention.

### BRIEF DESCRIPTION OF THE DRAWINGS

The present invention is described in greater detail in the following on the basis of the embodiments shown in the schematic figures of the drawings, in which:

FIG. 1 is a schematic depiction of a circuit arrangement for the fast discharge of a bias tee capacitor according to an embodiment of the present invention;

FIG. 2 is an electrical circuit with a particular implementation of a bias tee and a discharge circuit, showing the electrical components involved according to an embodiment of the present invention;

FIG. 3 is a schematic representation of the electrical circuit of FIG. 2, further including a pre-compensation circuit according to an embodiment of the present invention;

FIG. 4 is a schematic realization of the electrical circuit of FIG. 3, with an example of a pre-compensation circuit according to an embodiment of the present invention;

FIG. 5 is a block diagram showing the circuit arrangement of the invention according to an embodiment of the present invention where the discharge of the bias tee capacitor is performed with a circuit arrangement comprising two discharging switches;

FIG. 6 is a flowchart showing an exemplary embodiment of a method for discharging a bias tee capacitor according to an embodiment of the present invention;

FIG. 7 is a plot of voltage vs time showing a positive pulse train under pre-compensation, the charging level of the bias tee capacitor, and the output signal of the bias tee of a conventional discharge circuit arrangement with negative discharge pulse signal;

FIG. 8 is a plot of voltage vs time showing a positive pulse train under pre-compensation, the charging level of the bias tee capacitor, and the output signal of the bias tee according to an embodiment of the present invention with negative discharge pulse signal;

FIG. 9 is a plot of voltage vs time showing the charging level of the bias tee capacitor and the output signal of the bias tee according to an embodiment of the present invention with two discharging switches and no negative discharge pulse signal; and

FIG. 10 is a schematic representation of a quantum signal generator comprising a radiofrequency generator and a circuit arrangement according to an embodiment of the first aspect of the present invention.

The appended drawings are intended to provide further understanding of the embodiments of the invention. They illustrate embodiments and, in conjunction with the description, help to explain principles and concepts of the invention. Other embodiments and many of the advantages mentioned become apparent in view of the drawings. The elements in the drawings are not necessarily shown to scale.

In the drawings, like, functionally equivalent and identically operating elements, features and components are provided with like reference signs in each case, unless stated otherwise.

### DETAILED DESCRIPTION OF THE DRAWINGS

The detailed description includes specific details for the purpose of providing a thorough understanding of the present invention. However, it will be apparent to those skilled in the art that the present invention may be practised without these specific details.

The numeration of the steps in the methods are meant to ease their description. They do not necessarily imply a certain ordering of the steps. In particular, several steps may be performed concurrently.

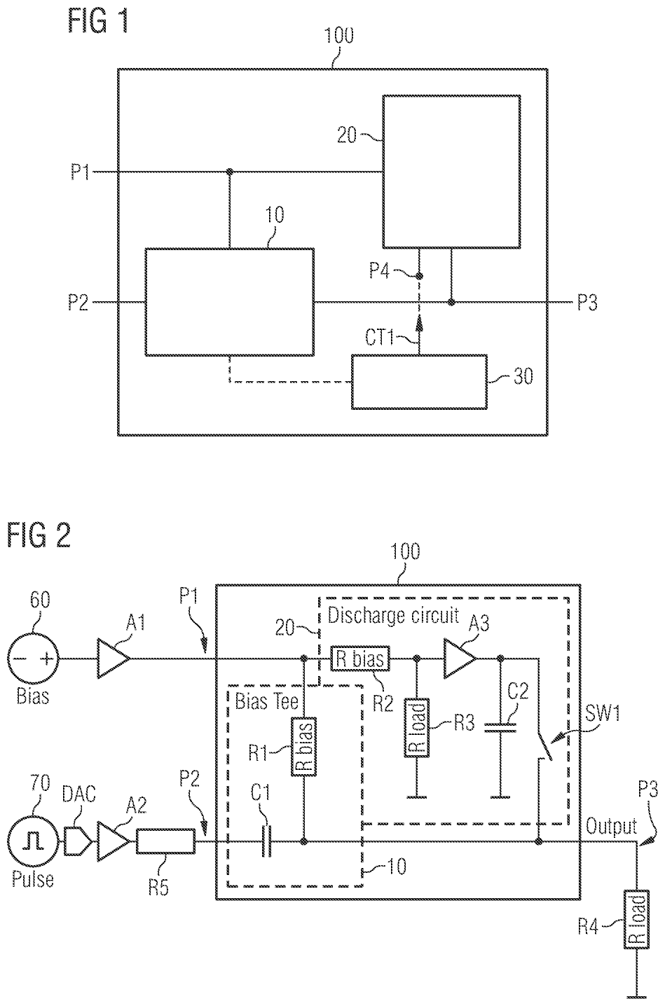

FIG. 1 shows a schematic depiction of a circuit arrangement 100 for the fast discharge of a bias tee capacitor C1 according to an embodiment of the present invention.

The circuit arrangement 100 depicted in FIG. 1 comprises a bias tee 10, a discharge circuit 20, and a discharge control unit 30, which are electrically connected with one another.

The bias tee 10 has an input DC terminal P1, an input AC terminal P2 and an output interface P3. The bias tee 10 is adapted to apply a DC signal and a radiofrequency (RF) signal to a device under test (DUT), which can be connected to the output interface P3. In some preferred embodiments of the invention, the DUT is a spin qubit or a superconducting qubit. The bias tee 10 further contains a number of passive electric components, including the bias tee capacitor C1 (not shown).

The input DC terminal P1 is adapted to receive at least a bias DC signal, which can be generated by a bias generator 60, such as the one shown in FIG. 2. The input AC terminal P2 is adapted to receive at least an RF signal. This signal can be generated by a radiofrequency generator 70, such as the one shown in FIG. 2. The radiofrequency generator 70 can be, e.g., an arbitrary waveform generator AWG, or a quantum AWG. In some preferred embodiments of the invention, the input AC terminal P2 is adapted to receive an RF signal, preferably a microwave signal. In these embodiments, the high-frequency signal can have a frequency between 1 GHz and 10 GHz, i.e., an ultra high frequency (UHF) or super high frequency (SHF), which are the frequency ranges needed, e.g., in quantum computing applications to excite and control qubits.

The signal generated by the radiofrequency generator 70 can in general comprise a DC component, e.g., if the signal is unipolar. The bias tee is adapted to block this DC component from entering the input AC terminal P2 with the use of the bias tee capacitor C1.

The generated RF signal can be a positive pulse train signal during the control time of the DUT, or a negative discharge pulse signal, which can be applied during the discharging of the bias tee capacitor C1.

The discharge circuit 20 is adapted to discharge the bias tee capacitor C1. In some preferred embodiments, such as the one shown in FIG. 1, the discharge circuit 20 can be connected to the bias tee 10 through the input DC terminal P1 and the output interface P3.

In some other embodiments, the discharge circuit 20 can comprise a control terminal P4, adapted to receive a control signal.

FIG. 1 also shows a discharge control unit 30, which is adapted to provide a control signal CT1 to control the discharge of the bias tee capacitor C1. The discharge control unit 30 can be any device that can obtain and process generic data from voltages and/or currents corresponding to different points of the circuit arrangement 100 of the invention. The discharge control unit 30 can be connected to the discharge circuit 20 through its control terminal P4 and at least to parts of the bias tee 10, in particular to the bias tee capacitor C1, in order to control its discharge.

FIG. 2 shows a particular implementation of the circuit arrangement 100 of the invention, with electrical circuits for both the bias tee 10 and the discharge circuit 20.

The bias tee 10 contains a bias tee capacitor C1 on the connection to the input AC terminal P2, which blocks potential DC components of the RF signal received from a radiofrequency generator 70 (e.g., an AWG). The bias tee 10 further comprises a passive component in the form of a resistor R1, which is connected to the input DC terminal P1. The input DC terminal P1 is in turn connected to a bias generator 60. Amplifiers A1 and A2 can be placed, respectively, between the bias generator 60 and the bias tee 10 and between the radiofrequency generator 70 and the bias tee 10. A resistor R5 can also placed between the amplifier A2 and the input AC terminal P2. FIG. 1 also contains a digital to analog converter DAC, which is provided between the radiofrequency generator 70 and the amplifier A2. Upon receiving a digital RF signal (either a digital positive pulse train signal or a digital negative discharge pulse signal), the digital to analog converter DAC is configured to convert the digital RF signal to a corresponding analog RF signal.

In the embodiment shown in FIG. 2, the discharge circuit 20 comprises a discharge switch SW1, a voltage divider and an amplifier A3.

The voltage divider comprises resistors R2 and R3, where R2 is connected to the input DC terminal P1 of the bias tee 10, and R3 is connected to ground. The voltage divider is connected in series with the amplifier A3. The amplifier A3 is in turn connected to the discharge switch SW1. The discharge switch SW1 is connected to the amplifier A3 and to the output interface P3, which can be connected to a resistor R4 and to a DUT (not shown in FIG. 2).

The discharge switch SW1 is adapted to switch off the discharge circuit when a positive pulse train signal flows through the input AC terminal P2 and to switch on discharge circuit when a negative discharge pulse signal flows through the input AC terminal P2. During the duration of a positive pulse train signal, the discharge circuit 20 is thus idle (the discharge circuit 20 is switched off). Once a positive pulse train signal has been completed, the discharge switch SW1 is switched on and the discharge circuit 20 thereby provides a discharge path to the bias tee capacitor C1.

The operation of the discharge switch SW1 can be controlled by the discharge control unit 30 shown in FIG. 1. In some preferred embodiments of the invention, the discharge switch SW1 can be switched off when the bias tee capacitor C1 has been fully discharged, only partially discharged, or as soon as a new positive pulse train signal is applied or is ready to be applied to the input AC terminal of the bias tee 10. By discharging the bias tee capacitor C1 only to a certain level (e.g., to a 10%), a new RF signal can be brought sooner into the bias tee 10.

In some preferred embodiments of the invention, the discharge circuit 20 further comprises a capacitor C2 connected between the amplifier A3 and the ground.

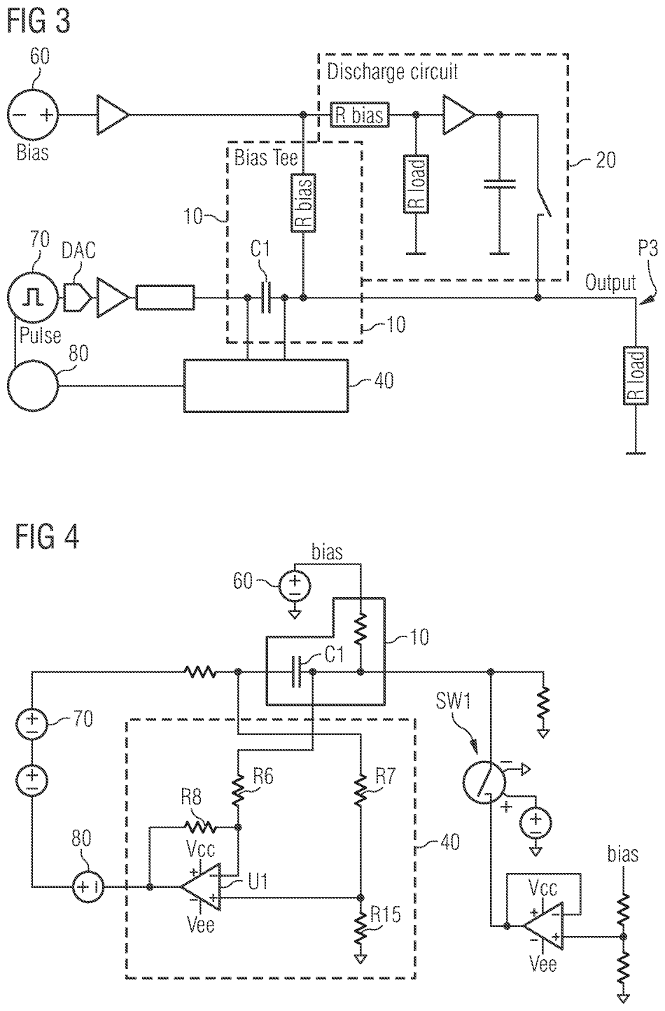

FIG. 3 shows a schematic representation of the electrical circuit of FIG. 2, further including a pre-compensation circuit 40 according to an embodiment of the present invention.

A pre-compensation circuit 40 is designed to modify the positive pulse train signal generated by a radiofrequency generator 70, such that the progressive charging of the bias tee capacitor C1 gets compensated for. As a result, the output signal to be released through the output interface P3 is not distorted and a stable DC bias level can be provided to the device under test (DUT), e.g., a qubit. The pre-compensation circuit 40 can be connected at least to the legs of the bias tee capacitor C1, in order to obtain information about the capacitor voltage. This information determines the voltage to be provided by a pre-compensation voltage generator 80, which is connected to the radiofrequency generator 70 to provide the pre-compensation.

FIG. 4 shows a schematic realization of the electrical circuit of FIG. 3, with an example of a pre-compensation circuit 40 according to an embodiment of the present invention. The pre-compensation circuit 40 comprises resistors R7 and R15, which are placed between one of the legs of the bias tee capacitor C1 and an amplifier U1. It also comprises resistors R6 and R8, which connect the other leg of the bias tee capacitor C1 to the amplifier U1.

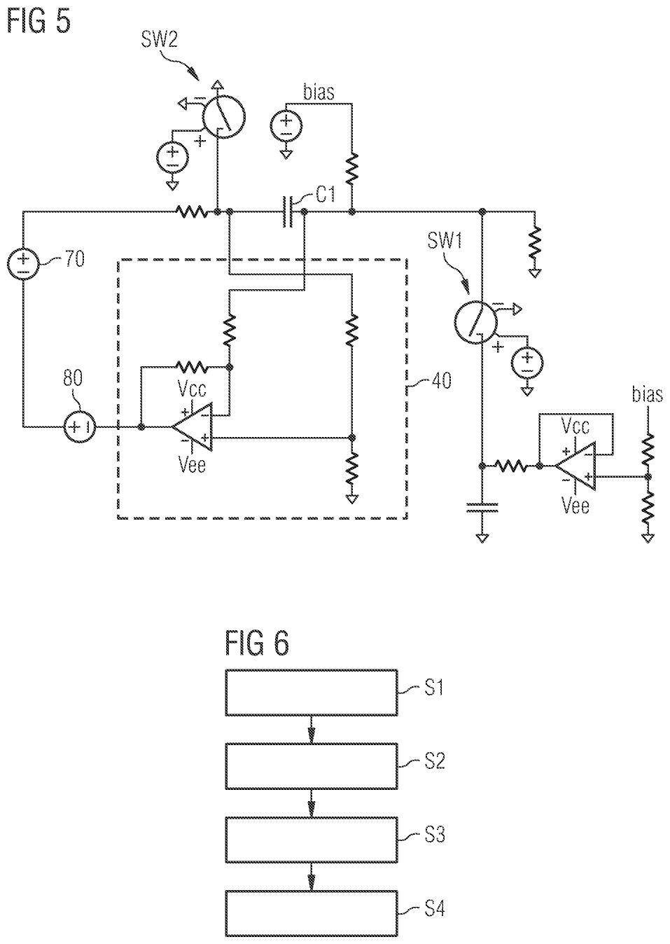

FIG. 5 shows a block diagram of the circuit arrangement 100 of the invention according to an embodiment of the present invention, where the discharge of the bias tee capacitor C1 is performed with a circuit arrangement 100 comprising two discharging switches SW1 and SW2. The discharge switch SW1 of the discharge circuit 20 is switched on when the discharging of the bias tee capacitor C1 starts. Preferably at the same time, a second discharge switch SW2, which is connected to the input AC terminal P2, is closed. According to this embodiment of the invention, the bias tee capacitor C1 is discharged from both sides, on the one side via the discharge circuit 20 and on the other side through the second discharge switch SW2. The operation of both discharge switches SW1 and SW2 can be controlled by the discharge control unit 30 (not shown). The discharge switches SW1 and SW2 can be independently operated.

FIG. 6 is a flowchart showing an exemplary embodiment of a method for discharging a bias tee capacitor according to an embodiment of the present invention. The method can be preferably implemented with the circuit arrangement 100 described with respect to FIG. 1 to FIG. 5. The method comprises a number of steps.

In a step S1, a circuit arrangement 100 with a bias tee 10 and a discharge circuit 20 is provided, the bias tee 10 having an input DC terminal P1, an output interface and an input AC terminal P2 comprising a bias tee capacitor C1.

In a step S2, a radiofrequency (RF) signal and a bias DC signal are received, respectively, at the input AC terminal P2 and the input DC terminal P1 of the bias tee 10. The RF signal comprises a radiofrequency positive pulse train signal. As the radiofrequency signal is received, its DC components are blocked with a bias tee capacitor C1, which gets accordingly charged.

In some embodiments of the invention, the RF signal can be pre-compensated, such that the charging of the bias tee capacitor C1 does not distort the output signal.

In another step S3, the bias tee capacitor C1 of the bias tee 10 is discharged with the deployment of a discharge circuit 20, which can be connected to the bias tee 10 as in any of the embodiments shown in FIGS. 1 to 5. The discharge circuit 20 can be activated by switching on a discharge switch SW1 when the radiofrequency positive pulse train signal has been completed.

The discharging of the bias tee capacitor C1 can be preferably eased with the generation of a negative discharge pulse signal. The discharge circuit 20 is, in particular, configured to reduce the impact of this negative discharge pulse signal on the output signal of the bias tee 10, both by diminishing the amplitude and duration of negative voltages in the output signal.

In a subsequent step S4, a control signal CT1 is provided by a discharge control unit 30, in order to control the discharge of the bias tee capacitor C1. This control signal CT1 can be, e.g., one of the following: the generation of a negative discharge pulse signal or the operation of one or more discharge switches (SW1 and/or SW2). In different embodiments of the invention, the discharge switches SW1 and SW2 can be controlled in different ways: i) to get switched on as soon as the discharge period has started, where this can be signaled by the end of the positive train pulse signal or the beginning of a negative discharge pulse signal; ii) to get switched off when the bias tee capacitor C1 has reached a certain discharge level, in particular when it has been fully discharged; or iii) to get switched off as soon as a new positive train pulse signal is received by the bias tee 10.

In most of the applications, sequences of the steps S2 to S4 are meant to be repeated more than once.

For instance, a positive RF signal of a certain width is received (step S2) by the circuit arrangement 100 to control or bias, e.g., a qubit. After a certain time (of the order of 50 ns to 100 ns), the signal is interrupted and the bias tee capacitor C1 is discharged using the discharge circuit 20 (step S3). After discharging the bias tee capacitor C1 (fully or to a certain level), the circuit arrangement 100 can receive another RF train pulse signal (step S2). This sequence, or similar ones involving the steps S2 to S4, can be iterated an arbitrary number of times.

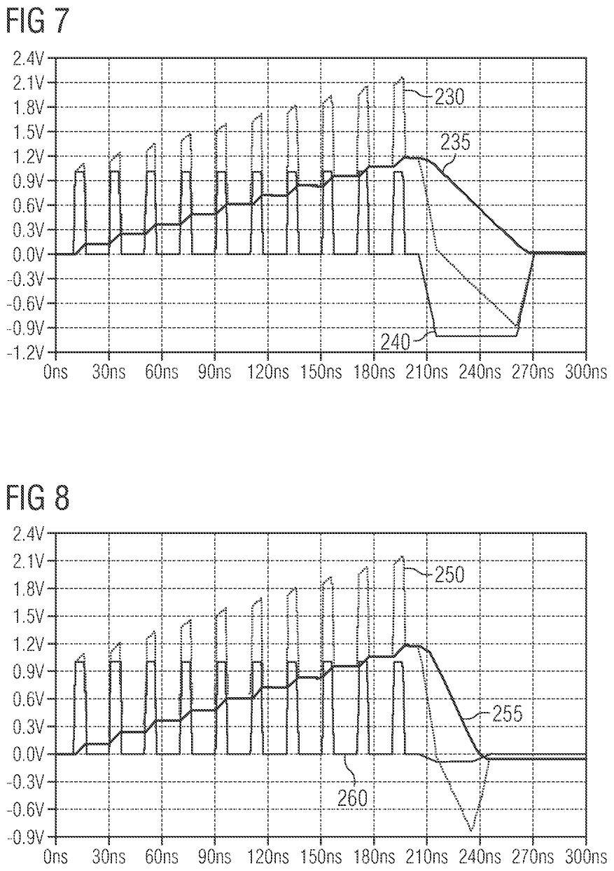

FIG. 7 shows a plot of the time evolution of the voltage at three different points of a conventional bias tee during the reception of a positive pulse train signal (a square wave train pulse with a 30% duty cycle) consisting of 10 pulses, each pulse with a width of 5 ns, and the posterior reception of a negative discharge pulse of a width of approximately 65 ns. Both the positive train pulse and the negative discharge pulse were generated by a radiofrequency generator 70, e.g., a quantum arbitrary waveform generator (Q-AWG). The plot has been obtained with the configuration shown in from FIG. 4, but without deploying the discharge circuit 20.

The positive train pulse has undergone a pre-compensation, e.g., with the help of the pre-compensation circuit 40, such as the one described with respect to FIGS. 3 and 4. The input RF signal 230 shows the pre-compensated positive train pulse signal, with a progressive increase of its voltage. This increase of the voltage is related to the charging level of the bias tee capacitor C1. The capacitor voltage signal 235 shows the voltage between the plates of the bias tee capacitor C1, which was initially completely discharged and, after the positive train pulse train signal has been received, has developed a potential of 1.2V. During the reception of the positive train pulse signal, the output signal 240 of the bias tee shows a square wave train, where the output voltage of each pulse is set at 1V. This constant voltage value of the pulses of the output signal 240 is a consequence of the pre-compensation.

The discharge of the bias tee capacitor C1 is performed with the help of an input RF signal 230, which takes the form of a negative discharge pulse, with a width of approximately 60 ns. During this time, the capacitor voltage signal 235 decreases approximately linearly until the bias tee capacitor C1 is fully discharged. The output signal 240 experiences during this 60 ns a negative voltage of −1V.

FIG. 8 shows a plot of the time evolution of the voltage at three points of a bias tee according to an embodiment of the invention during the reception of a positive pulse train signal followed by a negative pulse train signal, which both have of the same characteristics as the corresponding signals described with respect to FIG. 7. The plots were generated with the configuration shown in FIG. 4, including the deployment of the discharge circuit 20 of the invention.

The three points where the voltage was monitored are the same as the ones described with respect to FIG. 7. FIG. 8 shows an input RF signal 250, a capacitor voltage signal 255 and an output signal 260.

The input RF signal 250 comprises a pre-compensated positive train pulse signal followed by a negative discharge pulse signal.

During the reception of the positive train pulse signal, the different monitored signals 150, 255 and 260 follow the same evolution curves as described in FIG. 7.

The differences with respect to FIG. 7 appear during the discharge time. In FIG. 8, a negative discharge pulse signal is applied to discharge the bias tee capacitor C1. According to the invention, the discharge circuit 20 is now active, e.g., the discharge control unit 30 has closed the discharge switch SW1 when the negative discharge pulse signal was initiated. This causes the bias tee capacitor C1 to gets discharged a factor 2 faster than with the conventional circuit arrangement of FIG. 7. In approximately 30 ns, as opposed to the 60 ns shown in FIG. 7, the bias tee capacitor C1 can be fully discharged.

Additionally, in contrast to what is shown in FIG. 7, the output signal 260 does develop a much milder negative voltage during the discharge time. The circuit arrangement 100 of the invention therefore discharges the bias tee capacitor C1 twice as fast as a conventional discharging circuit arrangement and, furthermore, attenuates the impact of the negative discharge pulse signal on the output signal 260 by one order of magnitude (−0.1V in FIG. 8 to be compared with the −1V of FIG. 7).

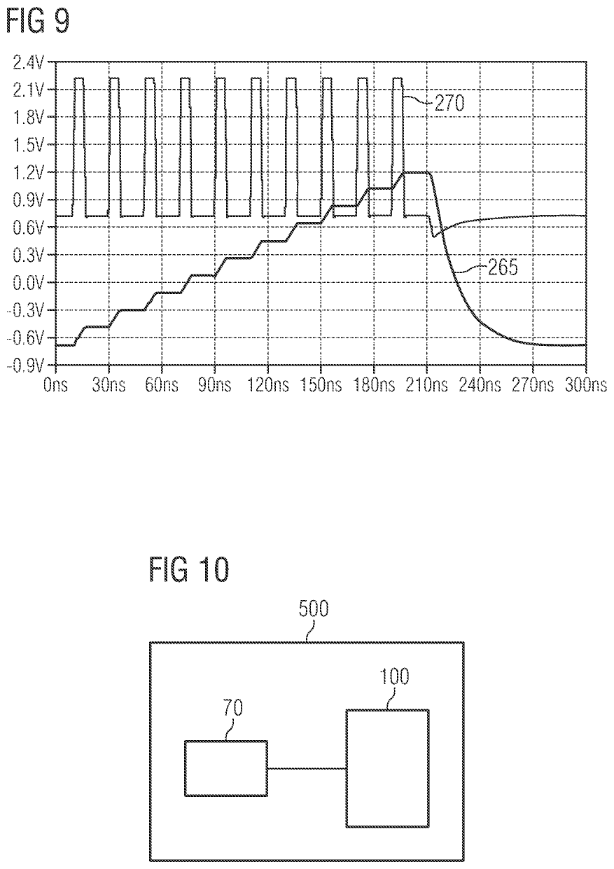

FIG. 9 shows a plot of voltage vs time of the capacitor voltage signal 265 and the output signal 270 of the bias tee 10 according to an embodiment of the present invention, where the circuit arrangement 100 of the invention comprises two discharging switches SW1 and SW2 and no negative discharge pulse signal has been applied during the discharge time. The configuration of the circuit arrangement 100 corresponds to the one depicted in FIG. 5, while the positive pulse train signal has the same characteristics as the corresponding signals described with respect to FIGS. 7 and 8. FIG. 9 shows that the bias tee capacitor C1 gets discharged with a speed comparable to the configurations discussed in FIGS. 7 and 8. The switching on of the two discharge switches SW1 and SW2 produces a spike in the output signal 270. The amplitude of the spike can be optimized by increasing the resistance associated with any of the discharging switches SW1 and SW2.

FIG. 10 shows a schematic representation of a quantum signal generator 500 comprising a radiofrequency generator 70 and a circuit arrangement 100 according to an embodiment of the first aspect of the present invention. The radiofrequency generator 70 can be an arbitrary waveform generator (AWG), adapted to generate radiofrequency (RF) signals for quantum computing applications. The AWG is preferably a quantum AWG (Q-AWG), configured to generate RF signals with microwave frequencies, such as the ones employed to bias and control qubits. The circuit arrangement 100 of the invention is configured to receive the radiofrequency signal generated by the radiofrequency generator 70 through the input AC terminal P2 of the bias tee 10.

The quantum signal generator circuit arrangement 500 can also comprise a bias generator 60 for the generation of a DC bias signal.

The previous description of the disclosed embodiments are merely examples of possible implementations, which are provided to enable any person skilled in the art to make or use the present invention. Various variations and modifications of these embodiments will be readily apparent to those skilled in the art, and the generic principles defined herein may be applied to other embodiments without departing from the spirit or scope of the present disclosure. Thus, the present invention is not intended to be limited to the embodiments shown herein but it is to be accorded the widest scope consistent with the principles and novel features disclosed herein. Therefore, the present invention is not to be limited except in accordance with the following claims.

In the foregoing specification, the invention has been described with reference to specific examples of embodiments of the invention. It will, however, be evident that various modifications and changes may be made therein without departing from the broader spirit and scope of the invention as set forth in the appended claims. For example, the connections between various elements as shown and described with respect to the drawings may be a type of connection suitable to transfer signals from or to the respective nodes, units or devices, for example via intermediate devices. Accordingly, unless implied or stated otherwise the connections may for example be direct connections or indirect connections.

Because the apparatuses implementing the present invention are, for the most part, composed of electronic components and circuits known to those skilled in the art, details of the circuitry and its components will not be explained in any greater extent than that considered necessary as illustrated above, for the understanding and appreciation of the underlying concepts of the present invention and in order not to obfuscate or distract from the teachings of the present invention.

Also, the invention is not limited to physical devices or units implemented in non-programmable hardware, but can also be applied in programmable devices or units able to perform the desired device functions by operating in accordance with suitable program code. Furthermore, the devices may be physically distributed over a number of apparatuses, while functionally operating as a single device. Devices functionally forming separate devices may be integrated in a single physical device. Those skilled in the art will recognize that the boundaries between logic or functional blocks are merely illustrative and that alternative embodiments may merge logic or functional blocks or impose an alternate decomposition of functionality upon various logic or functional blocks.

In the description, any reference signs shall not be construed as limiting the claim. The word “comprising” does not exclude the presence of other elements or steps then those listed in a claim. Furthermore, the terms “a” or “an”, as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage. The order of method steps as presented in a claim does not prejudice the order in which the steps may actually be carried out, unless specifically recited in the claim.

Skilled artisans will appreciate that the illustrations of chosen elements in the drawings are only used to help to improve the understanding of the functionality and the arrangements of these elements in various embodiments of the present invention. Also, common and well understood elements that are useful or necessary in a commercially feasible embodiment are generally not depicted in the drawings in order to facilitate the understanding of the technical concept of these various embodiments of the present invention. It will further be appreciated that certain procedural stages in the described methods may be described or depicted in a particular order of occurrence while those skilled in the art will understand that such specificity with respect to sequence is not actually required.

What we claim is:

1. A circuit arrangement, comprising:
a bias tee having
an input AC terminal comprising a bias tee capacitor, wherein the input AC terminal is adapted to receive at least one AC signal, wherein the AC signal comprises at least one of a positive pulse train signal and a negative discharge pulse signal;
an input DC terminal, adapted to receive at least one bias DC signal; and
an output interface, adapted to output a signal based on the received AC signal and the received bias DC signal, and
a discharge circuit, adapted to discharge the bias tee capacitor.

2. The circuit arrangement of claim 1, wherein the input DC terminal comprises a passive component, wherein the passive component is one of a resistor, an inductance, a capacitor or any combination thereof.

3. The circuit arrangement of claim 1, wherein the input AC terminal is adapted to receive a radiofrequency signal or a microwave signal.

4. The circuit arrangement of claim 1, wherein the discharge circuit is connected between the input DC terminal and the output interface.

5. The circuit arrangement of claim 4, wherein the discharge circuit comprises a discharge switch connected to the output interface and adapted to switch on and switch off the discharge circuit based on the AC signal.

6. The circuit arrangement of claim 5, wherein the discharge switch is adapted to switch on the discharge circuit when the AC signal is a positive pulse train signal and to switch off the discharge circuit when the AC signal is a negative discharge pulse signal.

7. The circuit arrangement of claim 5, wherein the discharge switch of the discharge circuit is adapted to switch the discharge circuit when the bias tee capacitor has been fully or at least partially discharged or when a positive pulse train signal is applied to the input AC terminal.

8. The circuit arrangement of claim 5, wherein the discharge circuit further comprises at least one of a voltage divider and an amplifier.

9. The circuit arrangement of claim 1, wherein the discharge circuit comprises a control terminal for receiving a control signal and the circuit arrangement further comprises a discharge control unit, which is connected to the control terminal and which is configured to provide a control signal to the control terminal to control the discharge of the bias tee capacitor.

10. The circuit arrangement of claim 9, wherein the discharge control unit is further configured to generate a negative discharge pulse signal.

11. The circuit arrangement of claim 5, wherein the discharge control unit is further configured to switch on the discharge circuit when a negative discharge pulse signal is received at the input AC terminal.

12. The circuit arrangement of claim 1, wherein the output interface comprises a DUT connection terminal, which is configured such to be coupled to a qubit.

13. The circuit arrangement of claim 1, further comprising a pre-compensation circuit, configured to modify a positive train pulse signal based on the charging level of the bias tee capacitor.

14. The circuit arrangement of claim 1, wherein at least one of the pulse train signal and the discharging pulse signal received by the input AC terminal are digital signals.

15. The circuit arrangement of claim 14, further comprising at least one digital to analog converter, arranged at the input AC terminal in order to receive at least one of a digital positive pulse train signal and a digital negative discharge pulse signal and configured to convert the at least one of the digital positive pulse train signal and the digital negative discharge pulse signal into an analog positive pulse train signal and an analog negative discharge pulse signal, respectively.

16. The circuit arrangement of claim 1, further comprising a second discharge switch arranged at the input AC terminal and adapted to be switched off after a positive pulse train signal has been received.

17. The circuit arrangement of claim 1, further configured to receive a positive pulse train signal at least every 30 ns.

18. A method for discharging a bias tee capacitor, the method comprising:
providing a circuit arrangement with a bias tee and a discharge circuit, the bias tee having an input DC terminal, an output interface and an input AC terminal comprising a bias tee capacitor;
receiving at least one AC signal comprising a positive pulse train signal at the input AC terminal and at least a bias DC signal at the input DC terminal; and
discharging the bias tee capacitor by employing the discharge circuit.

19. The method of claim 18, further comprising:
providing a control signal to control the discharge of the bias tee capacitor.

20. A quantum signal generator, comprising:
a radiofrequency generator, adapted to generate a radiofrequency signal; and
a circuit arrangement, comprising: a bias tee having an input AC terminal comprising a bias tee capacitor, wherein the input AC terminal is adapted to receive at least one AC signal, wherein the AC signal comprises at least one of a positive pulse train signal and a negative discharge pulse signal; an input DC terminal, adapted to receive at least one bias DC signal; and an output interface, adapted to output a signal based on the received AC signal and the received bias DC signal, and a discharge circuit, adapted to discharge the bias tee capacitor, wherein the circuit arrangement is configured to receive the radiofrequency signal generated by the radiofrequency generator through the input AC terminal.
